(19) United States
(12) Patent Application Publication
(10) Pub. No.: US 2010/0096606 A1
(43) Pub. Date: Apr. 22, 2010

(54) Hydraulic jack for pallet truck

(76) Inventor: Wen-Ching Lee, Taipei Hsien (TW)

Correspondence Address: WEGMAN, HESSLER & VANDERBURG, 6055 ROCKSIDE WOODS BOULEVARD, SUITE 200, CLEVELAND, OH, 44131, US

(21) Appl. No.: 12/288,039

(22) Filed: Oct. 16, 2008

(51) Int. Cl. B60P 1/48

(52) U.S. Cl. 254/10 C

(57) ABSTRACT

The main objective of the present invention is to provide a hydraulic jack for a pallet truck that has multiple pumping units. The hydraulic jack has a platform and a base plate being mounted on a mounting bracket. A holding frame protruding from the mounting bracket and has a gap. A main pumping unit, a secondary pumping unit and a lifting unit are mounted on a top surface of the base plate. The lifting unit is connected to the platform. The secondary pumping unit has an extension rod being selectively pushed into the gap to selectively lock the secondary pumping unit. Therefore, the user may choose to use one or two pumping units as desired.

### BACKGROUND OF THE INVENTION

1. Field of the Invention

The present invention relates to a hydraulic jack for a pallet truck, especially to a hydraulic jack that has multiple pumping units to adjust the lifting distance.

2. Description of the Prior Arts

The pallet trucks are used to transport goods, especially used in shopping mail or storehouse. The pallet truck as shown in U.S. Pat. No. 4,589,669, which is incorporated herein by reference, has a conventional hydraulic jack. The conventional hydraulic jack has a lifting unit and a pumping unit. The lifting unit has a lifting cylinder and a lifting rod connected to the platform to selectively lift the platform. The pumping unit is connected to the lifting unit through an elongated base plate and has a pumping cylinder and a pumping rod. When the user pivots a control rod to press down the pumping rod, the hydraulic fluid is pressed to push the lifting rod upward to lift the platform.

When the goods on the platform are lighter, the force exerted by the user to pivot the control rod is smaller. However, each time when the control rod is pivoted, the lift distance of the lifting rod is limited and is not influenced by the magnitude of the force that the user exerts to the control rod. Therefore, regardless the weight of the goods, the user needs to pivot the control rod for the same number of times to lift the platform to the same height. Thus, the conventional hydraulic jack is not convenient to use.

To overcome the shortcomings, the present invention provides a hydraulic jack to mitigate or obviate the aforementioned problems.

### SUMMARY OF THE INVENTION

The main objective of the present invention is to provide a hydraulic jack for a pallet truck that has multiple pumping units. The hydraulic jack has a platform and a base plate being mounted on a mounting bracket. A holding frame protruding from the mounting bracket and has a gap. A main pumping unit, a secondary pumping unit and a lifting unit are mounted on a top surface of the base plate. The lifting unit is connected to the platform. The secondary pumping unit has an extension rod being selectively pushed into the gap to selectively lock the secondary pumping unit. Therefore, the user may choose to use one or two pumping units as desired.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pallet truck with a hydraulic jack in accordance with the present invention;

FIG. 2 is a top view in partial section of the base plate of the hydraulic jack in FIG. 1;

FIG. 3 is a perspective view of the hydraulic jack in FIG. 1 being mounted on the pallet truck;

FIG. 4 is a front view in partial section of the hydraulic jack in FIG. 1 being mounted on the pallet truck;

FIG. 5 is an enlarged front view in partial section of the hydraulic jack in FIG. 1;

FIG. 6 is an enlarged rear view in partial section of the hydraulic jack in FIG. 1;

FIG. 7 is an operational perspective view of the hydraulic jack in FIG. 1 being mounted on the pallet truck;

FIG. 8 is an operational front view in partial section of the hydraulic jack in FIG. 1 being mounted on the pallet truck; and

FIG. 9 is an enlarged operational front view in partial section of the hydraulic jack in FIG. 1.

### DETAILED DESCRIPTION OF THE PREFERRED EMBODIMENTS

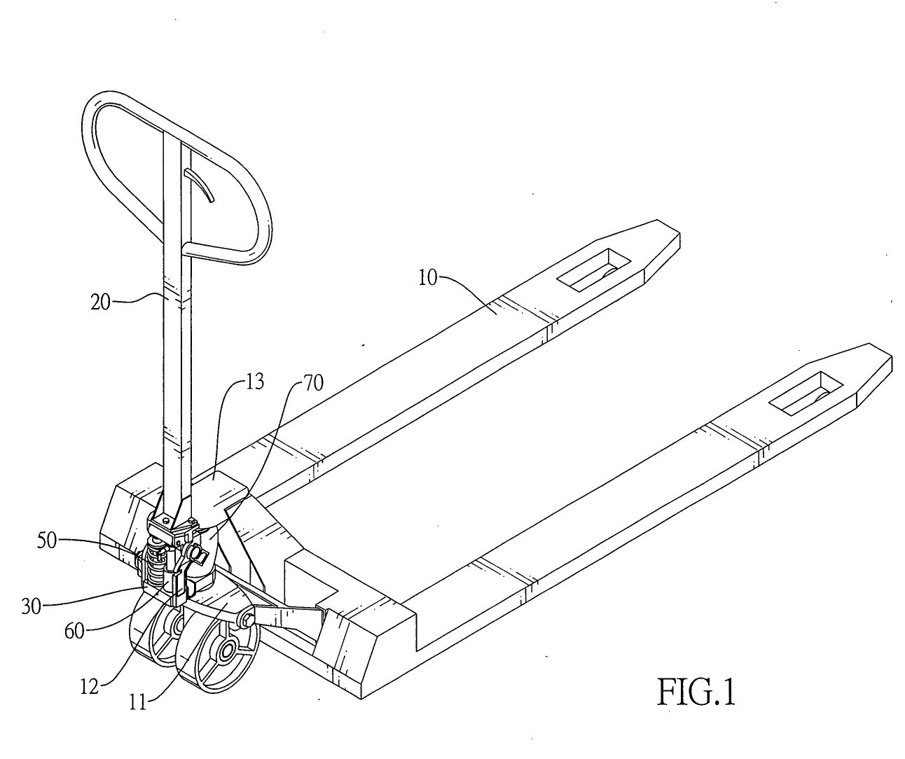

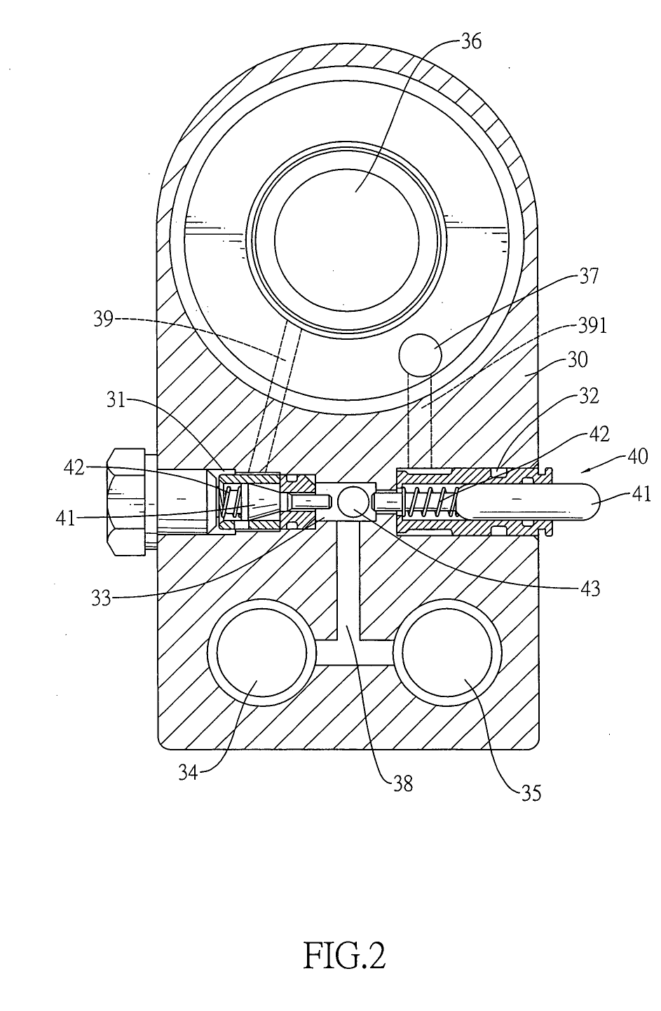

With reference to FIGS. 1 and 2, a hydraulic jack in accordance with the present invention comprises a platform (10), a control rod (20), a base plate (30), a cartridge assembly (40), a main pumping unit (50), a secondary pumping unit (60) and a lifting unit (70).

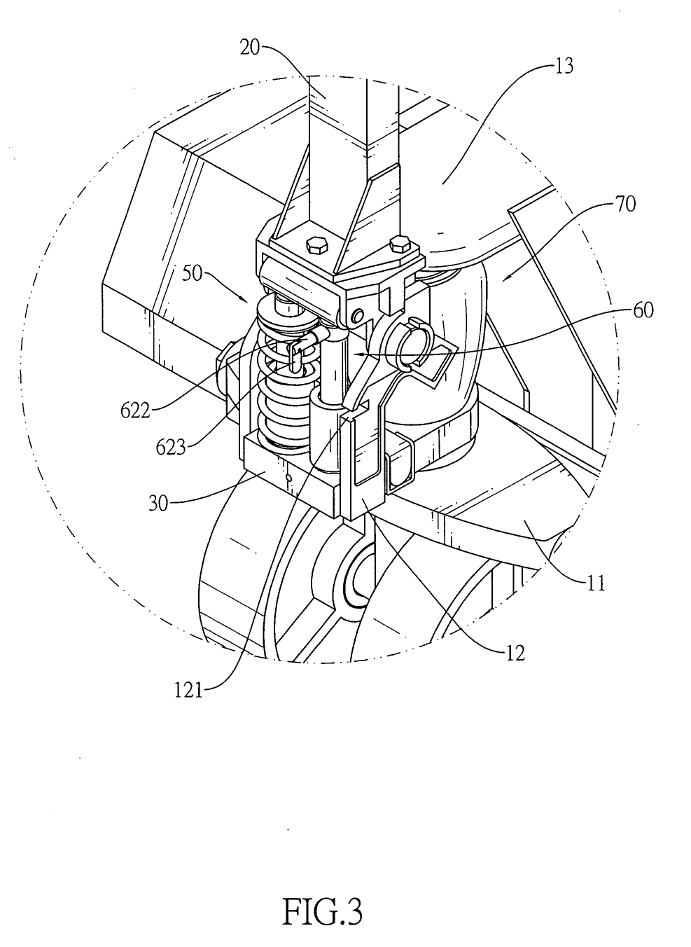

With reference to FIGS. 1 and 3, the platform (10) is used to carry goods and has a front end, a top surface, a mounting bracket (11), a holding frame (12) and a connecting bracket (13). The mounting bracket (11) protrudes out from the front end of the platform (10) and has a top surface. The holding frame (12) is formed on the top surface of the mounting bracket (11) and has a first side, a second side and a gap (121). The second side is opposite to the first side. The gap (121) is formed in the second side. The connecting bracket (13) is formed on the front end of the platform (10) and protrudes from the top surface of the platform (10).

The control rod (20) is connected pivotally to the holding frame (12).

With reference to FIGS. 1 and 2, the base plate (30) is attached securely to the top surface of the mounting bracket (11) between the first and second sides of the holding frame (12) and has a top surface, a front end, a rear end, a first side, a second side, a fluid route being formed inside the base plate (30) and a mounting rod (351). The second side is opposite to the first side. The fluid route comprises a first chamber (31), a second chamber (32), a connecting chamber (33), a first recess (34), a second recess (35), an opening (36), a fluid inlet (37), a first passage (38), a second passage (39) and a third passage (391). The first chamber (31) is formed transversely through the first side of the base plate (30). The second chamber (32) is formed transversely through the second side of the base plate (30) and aligns with the first chamber (31).

The connecting chamber (33) is formed between and communicates with the first and second chambers (31, 32). The first recess (34) is formed in the top surface of the base plate (30) and is near the front end of the base plate (30) and the first side of the base plate (30). The second recess (35) is formed in the top surface of the base plate (30) and is near the front end of the base plate (30) and the second side of the base plate (30). The opening (36) is formed in the top surface of the base plate (30) and is near the rear end of the base plate (30). The fluid inlet (37) is formed in the top surface of the base plate (30) and is adjacent to the opening (36). The first passage (38) is formed between and communicates with the connecting chamber (33), the first recess (34) and the second recess (35). The second passage (39) is formed between and communicates with the first chamber (31) and the opening (36). The third passage (391) is formed between and communicates with the second chamber (32) and the fluid inlet (37). The mounting rod (351) is mounted in the second recess (35) and protrudes out of the top surface of the base plate (30).

The cartridge assembly (40) is mounted in the fluid route in the base plate (30), may be a ball check valve and comprises two valve rods (41), two valve springs (42) and a ball (43). The valve rods (41) are mounted respectively in the first and second chambers (31, 32) in the base plate (30) and align with each other. The valve springs (42) are mounted respectively around the valve rods (41). The ball (43) is mounted movably in the connecting chamber (33). Because the cartridge assembly (40) is well known in the skill of the art, the unnecessary details of the related operation and the related structure are not described here.

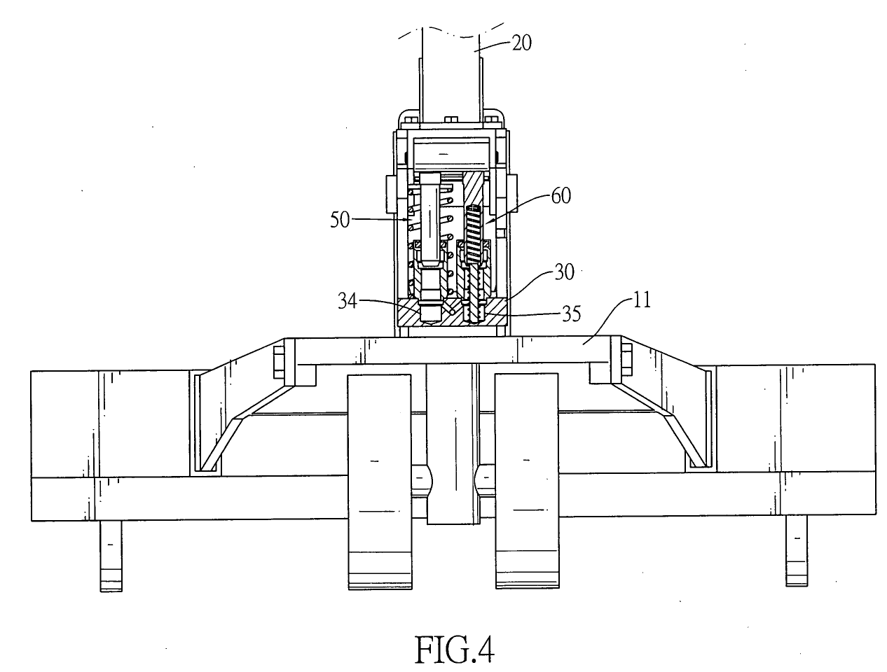

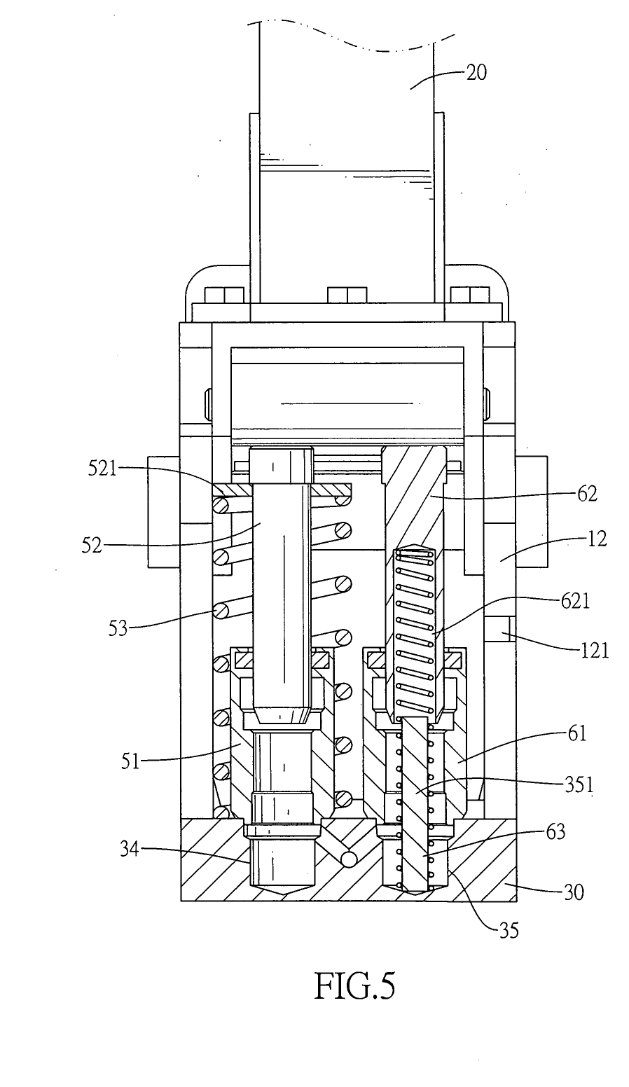

With reference to FIGS. 4 and 5, the main pumping unit (50) is mounted on the top surface of the base plate (30), is near the first side of the holding frame (12) and the front end of the base plate (30), communicates with the fluid route in the base plate (30) and corresponds to the control rod (20). The main pumping unit (50) has a main cylinder (51), a main piston (52) and a main spring (53). The main cylinder (51) covers on and communicates with the first recess (34) of the base plate (30). The main piston (52) is mounted movably through the main cylinder (51) and has a top end, a bottom end, an annular wall and a flange (521). The top end of the main piston (52) selectively abuts the control rod (20). The bottom end of the main piston (52) is mounted in the main cylinder (51). The flange (521) is formed around the annular wall of the main piston (52). The main spring (53) is mounted around the main cylinder (51) and the main piston (52) and is mounted between the top surface of the base plate (30) and the flange (521) of the main piston (52).

With reference to FIGS. 3 to 5, the secondary pumping unit (60) is mounted on the top surface of the base plate (30), is near the second side of the holding frame (12) and the front end of the base plate (30) and communicates with the fluid route in the base plate (30). The secondary pumping unit (60) has a secondary cylinder (61), a secondary piston (62) and a secondary spring (63).

The secondary cylinder (61) is mounted on the top surface of the base plate (20), communicates with the fluid route in the base plate (30) and may cover on and may communicate with the second recess (35) of the base plate (30). The secondary piston (62) is mounted movably and rotatably through the secondary cylinder (61) and has a top end, a bottom end, a mounting recess (621), an extension rod (622) and a handle (623). The top end of the secondary piston (62) selectively abuts the control rod (20). The bottom end of the secondary piston (62) is mounted in the secondary cylinder (61). The mounting recess (621) is formed axially in the bottom end of the secondary piston (62) and is mounted selectively around the mounting rod (351). The extension rod (622) is formed transversely on the top end of the secondary piston (62), is selectively pushed into the gap (121) and has a distal end. The handle (623) is formed on the distal end of the extension rod (622) to allow the user easily pivoting the secondary piston (62). The secondary spring (63) is mounted in the secondary cylinder (61) and is mounted between the secondary piston (62) and the base plate (30). The secondary spring (63) may be mounted around the mounting rod (351) and may be mounted in the mounting recess (621).

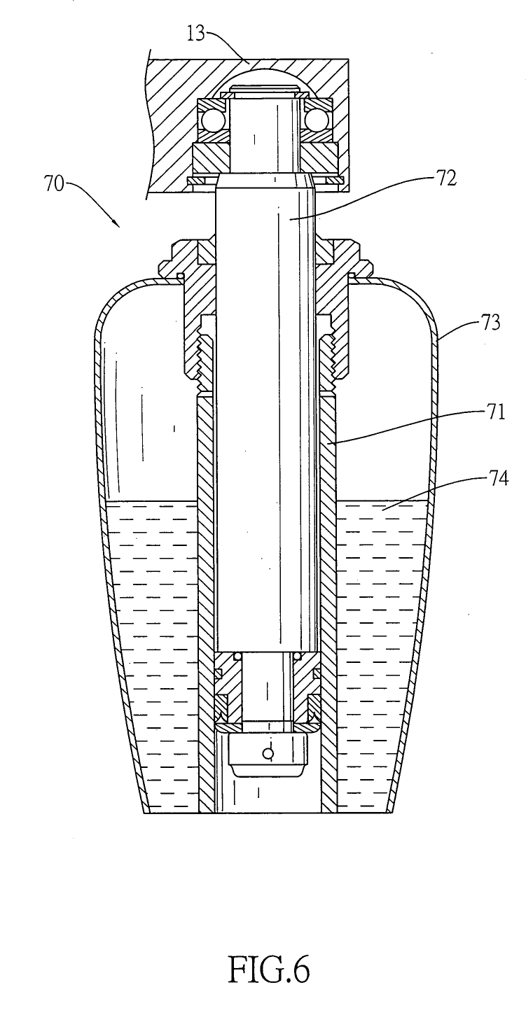

With reference to FIGS. 2 and 6, the lifting unit (70) is mounted on the top surface of the base plate (30) near the rear end of the base plate (30), communicates with the fluid route in the base plate (30) and corresponds to the connecting bracket (13). The lifting unit (70) has a lifting cylinder (71), a lifting rod (72), a reservoir (73) and fluid (74). The lifting cylinder (71) covers on and communicates with the opening (36) of the base plate (30). The lifting rod (72) is mounted movably through the lifting cylinder (71) and has a top end and a bottom end. The top end of the lifting rod (72) is attached securely to the connecting bracket (13). The bottom end of the lifting rod (72) is mounted in the lifting cylinder (71). The reservoir (73) is mounted around the lifting cylinder (71) and covers on and communicates with the fluid inlet (37). The fluid (74) is filled in the reservoir (73) and may be oil.

With reference to FIGS. 3 to 6, when the goods on the platform (10) is lighter, the main pumping unit (50) and the secondary pumping unit (60) are operated simultaneously. The control rod (20) is pivoted to repeatedly press the main piston (52) and the secondary piston (62) downwardly. The fluid is sucked out of the reservoir (73), flows through the route of the base plate (30) and is filled into the lifting cylinder (71) to push the lifting rod (72) upwardly. Therefore, the lifting rod (72) moves upwardly to lift the platform (10) through the connecting bracket (13).

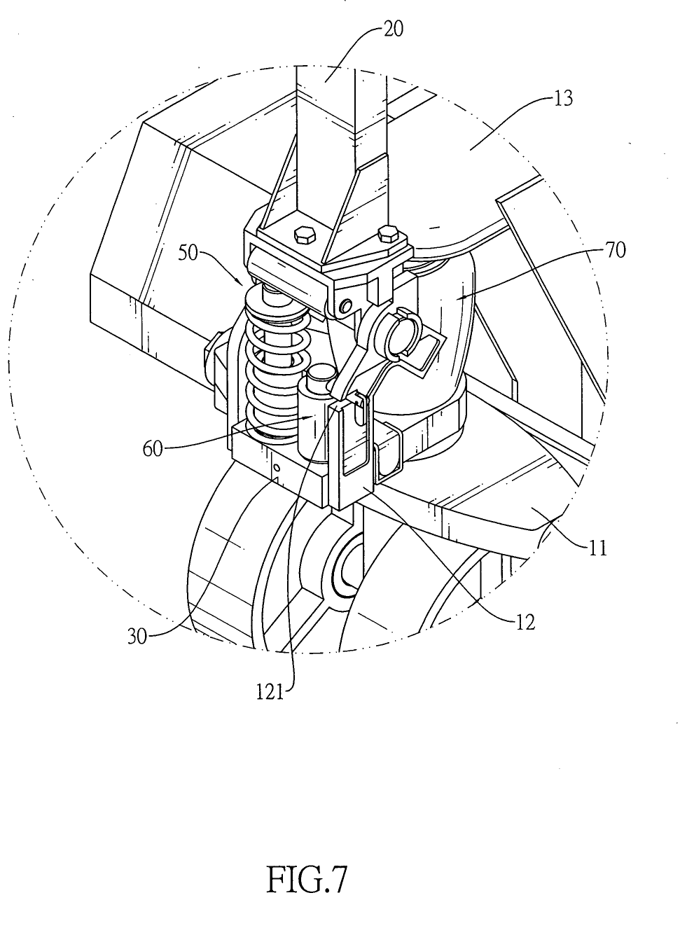

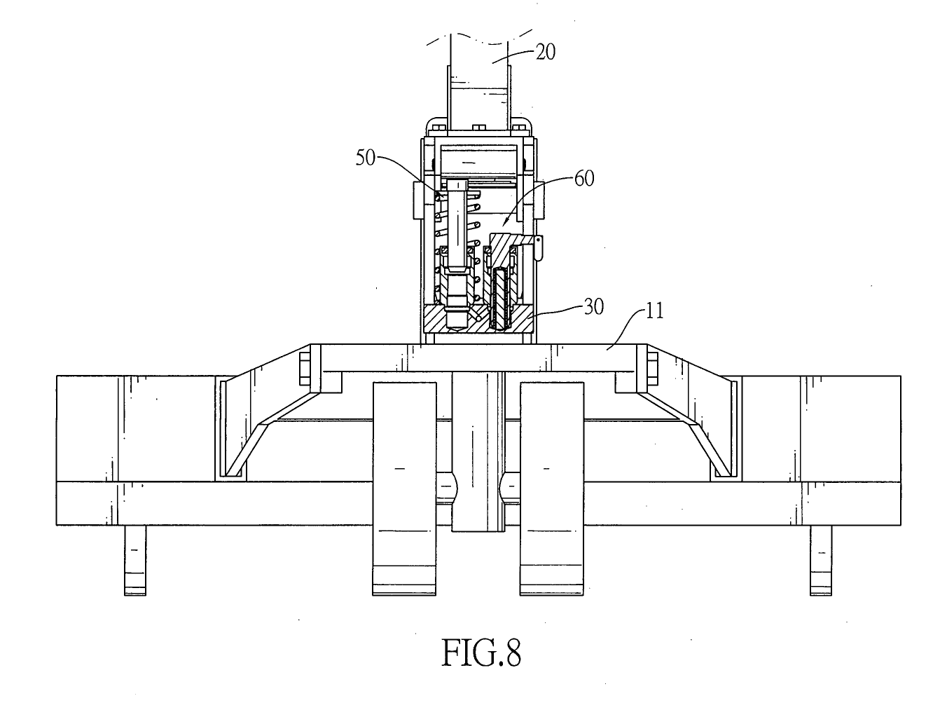

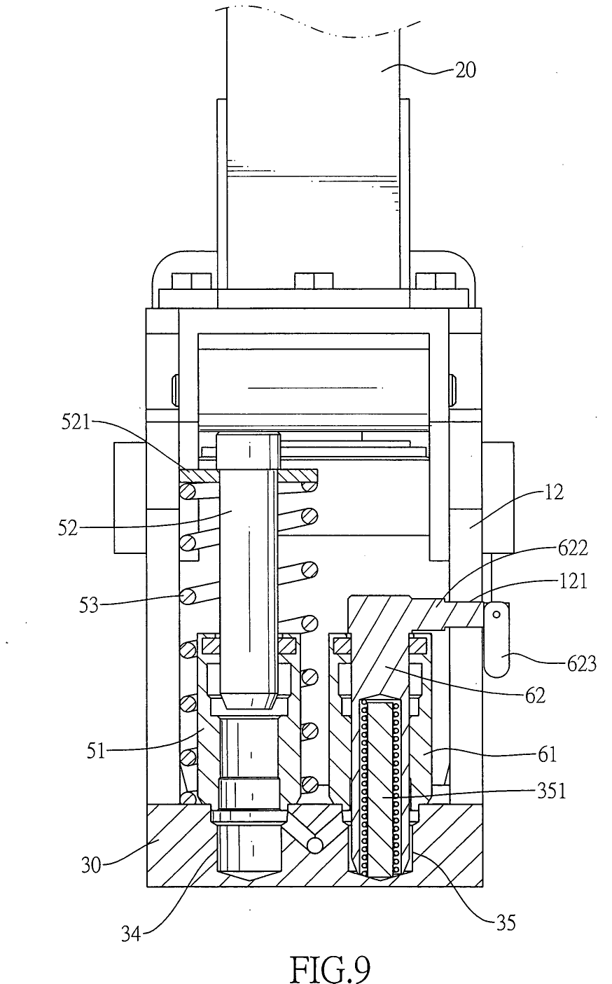

With reference to FIGS. 6 to 9, when the goods on the platform (10) is heavier, the main pumping unit (50) is operated alone. The secondary pumping piston (62) is pressed down and is rotated to push the extension rod (622) into the gap (121) of the holding frame (12). Thus, when the control rod (20) is pivoted repeatedly, the control rod (20) only presses the main piston (52) downwardly to lift the platform (10).

The hydraulic jack as described has numerous advantages. With the simultaneous operation of the main and secondary pumping units (50, 60), the lift distance of the platform (10) is greater when each time the control rod (20) is pivoted, and the platform (10) is quickly lifted to the desired height. With the extension rod (622) and gap (121) of the holding frame (12), the user may lock the secondary pumping unit (60) to reduce the pivoting force for the control rod (20). Therefore, the user may choose to use one or two pumping units as desired. When the goods on the platform (10) is heavier, the user may use two pumping units to lift the platform (10) quicker. When the goods on the platform (10) is lighter, the user may use only one pumping unit to reduce the pivoting force for the control rod (20). Furthermore, with the mounting rod (351), the fluid (74) is kept from flowing into the secondary cylinder (61) when the secondary pumping unit (60) is locked.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hydraulic jack comprising:
a platform having
a front end;
a top surface;
a mounting bracket protruding out from the front end of the platform and having a top surface;
a holding frame being formed on the top surface of the mounting bracket and having
a first side;
a second side being opposite to the first side; and
a gap being formed in the second side of the holding frame; and
a connecting bracket being formed on the front end of the platform and protruding from the top surface of the platform;
a control rod being connected pivotally to the holding frame;
a base plate being attached securely to the top surface of the mounting bracket between the first and second sides of the holding frame and having
a top surface;
a front end;
a rear end;
a first side;
a second side being opposite to the first side of the base plate;
a fluid route being formed inside the base plate;
a cartridge assembly being mounted in the fluid route in the base plate;
a main pumping unit being mounted on the top surface of the base plate, being near the first side of the holding frame and the front end of the base plate, communicating with the fluid route in the base plate and corresponding to the control rod;
a secondary pumping unit being mounted on the top surface of the base plate, being near the second side of the holding frame and the front end of the base plate, communicating with the fluid route in the base plate and having
a secondary cylinder being mounted on the top surface of the base plate, communicating with the fluid route in the base plate;
a secondary piston being mounted movably and rotatably through the secondary cylinder and having
a top end selectively abutting the control rod;
a bottom end being mounted in the secondary cylinder; and
an extension rod being formed transversely on the top end of the secondary piston and being selectively pushed into the gap; and
secondary spring being mounted in the secondary cylinder and being mounted between the secondary piston and the base plate; and
a lifting unit being mounted on the top surface of the base plate near the rear end of the base plate, communicating with the fluid route in the base plate and corresponding to the connecting bracket.

2. The hydraulic jack as claimed in claim 1, the extension rod of the secondary piston has
a distal end; and
a handle being formed on the distal end of the extension rod.

3. The hydraulic jack as claimed in claim 1, wherein
the fluid route of the base plate comprises
a first chamber being formed transversely through the first side of the base plate;
a second chamber being formed transversely through the second side of the base plate and aligning with the first chamber;
a connecting chamber being formed between and communicating with the first and second chambers
a first recess being formed in the top surface of the base plate and being near the front end of the base plate and the first side of the base plate;
a second recess being formed in the top surface of the base plate and being near the front end of the base plate and the second side of the base plate;
an opening being formed in the top surface of the base plate and being near the rear end of the base plate;
a fluid inlet being formed in the top surface of the base plate and being adjacent to the opening;
a first passage being formed between and communicating with the connecting chamber, the first recess and the second recess;
a second passage being formed between and communicating with the first chamber and the opening; and
a third passage being formed between and communicating with the second chamber and the fluid inlet;
the main pumping unit corresponds to the first recess of the base plate; and
the secondary cylinder of the secondary pumping unit covering and communicating with the second recess of the base plate.

4. The hydraulic jack as claimed in claim 2, wherein
the fluid route of the base plate comprises
a first chamber being formed transversely through the first side of the base plate;
a second chamber being formed transversely through the second side of the base plate and aligning with the first chamber;
a connecting chamber being formed between and communicating with the first and second chambers
a first recess being formed in the top surface of the base plate and being near the front end of the base plate and the first side of the base plate;
a second recess being formed in the top surface of the base plate and being near the front end of the base plate and the second side of the base plate;
an opening being formed in the top surface of the base plate and being near the rear end of the base plate;
a fluid inlet being formed in the top surface of the base plate and being adjacent to the opening;
a first passage being formed between and communicating with the connecting chamber, the first recess and the second recess;
a second passage being formed between and communicating with the first chamber and the opening; and
a third passage being formed between and communicating with the second chamber and the fluid inlet;
the main pumping unit corresponds to the first recess of the base plate; and
the secondary cylinder of the secondary pumping unit covering and communicating with the second recess of the base plate.

5. The hydraulic jack as claimed in claim 3, wherein the lifting unit has
a lifting cylinder covering on and communicating with the opening of the base plate;
a lifting rod being mounted movably through the lifting cylinder and having
a top end being attached securely to the connecting bracket; and
a bottom end being mounted in the lifting cylinder;
a reservoir being mounted around the lifting cylinder and covering on and communicating with the fluid inlet of the base plate; and
fluid being filled in the reservoir.

6. The hydraulic jack as claimed in claim 4, wherein the lifting unit has
a lifting cylinder covering on and communicating with the opening of the base plate;
a lifting rod being mounted movably through the lifting cylinder and having
a top end being attached securely to the connecting bracket; and
a bottom end being mounted in the lifting cylinder;
a reservoir being mounted around the lifting cylinder and covering on and communicating with the fluid inlet of the base plate; and
fluid being filled in the reservoir.

7. The hydraulic jack as claimed in claim 3, wherein the main pumping unit has
a main cylinder covering on and communicating with the first recess of the base plate;
a main piston being mounted movably through the main cylinder and having
a top end selectively abutting the control rod;
a bottom end being mounted in the main cylinder;
an annular wall; and
a flange being formed around the annular wall of the main piston;
a main spring being mounted around the main cylinder and the main piston and being mounted between the top surface of the base plate and the flange of the main piston.

8. The hydraulic jack as claimed in claim 6, wherein the main pumping unit has
a main cylinder covering on and communicating with the first recess of the base plate;
a main piston being mounted movably through the main cylinder and having
a top end selectively abutting the control rod;
a bottom end being mounted in the main cylinder;
an annular wall; and
a flange being formed around the annular wall of the main piston;
a main spring being mounted around the main cylinder and the main piston and being mounted between the top surface of the base plate and the flange of the main piston.

9. The hydraulic jack as claimed in claim 3, wherein
the base plate has a mounting rod being mounted in the second recess and protruding out of the top surface of the base plate;
the secondary piston has a mounting recess being formed axially in the bottom end of the secondary piston and being mounted selectively around the mounting rod; and
the secondary spring is mounted around the mounting rod and is mounted in the mounting recess of the secondary piston.

10. The hydraulic jack as claimed in claim 8, wherein
the base plate has a mounting rod being mounted in the second recess and protruding out of the top surface of the base plate;
the secondary piston has a mounting recess being formed axially in the bottom end of the secondary piston and being mounted selectively around the mounting rod; and
the secondary spring is mounted around the mounting rod and is mounted in the mounting recess of the secondary piston.

11. The hydraulic jack as claimed in claim 3, wherein the cartridge assembly comprises
two valve rods being mounted respectively in the first and second chambers in the base plate and aligning with each other;
two valve springs being mounted respectively around the valve rods; and
a ball being mounted movably in the connecting chamber of the base plate.

12. The hydraulic jack as claimed in claim 10, wherein the cartridge assembly comprises
two valve rods being mounted respectively in the first and second chambers in the base plate and aligning with each other;
two valve springs being mounted respectively around the valve rods; and
a ball being mounted movably in the connecting chamber of the base plate.
